(19) United States
(12) Patent Application Publication
(10) Pub. No.: US 2026/0266613 A1
(43) Pub. Date: Sep. 10, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventor: Kazuko NISHIMURA, Kyoto (JP)

(73) Assignee: PANASONIC INTELLECTUAL PROPERTY MANAGEMENT CO., LTD., Osaka (JP)

(21) Appl. No.: 19/661,342

(22) Filed: Apr. 28, 2026

Related U.S. Application Data
(63) Continuation of application No. PCT/JP2024/038097, filed on Oct. 25, 2024.
(60) Provisional application No. 63/546,997, filed on Nov. 2, 2023.

(30) Foreign Application Priority Data
Jun. 19, 2024 (JP) 2024-098839

(51) Int. Cl. G01C 21/20; G01C 5/06; G06T 7/73

(52) U.S. Cl. CPC G01C 21/206; G01C 5/06; G06T 7/74

(57) ABSTRACT

An information processing apparatus generates a photographing path from a photographing start spot to a photographing end spot having a plurality of floors, from a plurality of bird's-eye views covering the floors and a plurality of images captured at a plurality of photographing spots including the photographing start spot and the photographing end spot, and links, on the basis of elevation information indicative of an elevation of each of the photographing spots, a photographing spot in a first photographing section having a constant elevation to a first bird's-eye-view among the bird's-eye views, and a photographing spot in a second photographing section having a constant elevation after an elevation change to a second bird's-eye view among the bird's-eye views and different from the first bird's-eye view.

### FIELD OF INVENTION

The present disclosure relates to a technique for mapping a photographing path.

### BACKGROUND ART

Patent Literature 1 discloses a management system configured to associate movement information of an on-site operator obtained by pedestrian dead-reckoning means with a detection result of an on-site material and an identification tag by detection means in accordance with time, and store it in a database. It is disclosed that this management system allows the on-site operator to photograph a plurality of materials in a construction site while walking in the construction site with carrying the pedestrian dead-reckoning means and a photography recording device, and to move within each floor from a start spot provided with an identification tag on each floor. Each identification tag is associated with elevation information indicating a horizontal position and an elevational position (floor) of a location provided with the identification tag in the construction site.

However, in the technique of Patent Literature 1, an identification tag must be provided at a movement start spot on each of the floors to obtain the movement information for each of the floors.

The present disclosure has been made in order to solve the problem described above, and an object thereof is to provide a technique that makes it possible to obtain a photographing path on each of a plurality of floors without inputting a photographing start spot on each of the floors.

Patent Literature 1: Japanese Unexamined Patent Publication No. 2022-92364

### SUMMARY OF THE INVENTION

An information processing method according to an aspect of the present disclosure is an information processing method by a computer, and includes generating a photographing path from a photographing start spot to a photographing end spot having a plurality of floors, from a plurality of bird's-eye views covering the floors and a plurality of images captured at a plurality of photographing spots including the photographing start spot and the photographing end spot; and linking, on the basis of elevation information indicative of an elevation of each of the photographing spots, a photographing spot being in a first photographing section having a constant elevation to a first bird's-eye view among the bird's-eye views, and a photographing spot being in a second photographing section having a constant elevation after an elevation change to a second bird's-eye view among the bird's-eye views and different from the first bird's-eye view.

The present disclosure makes it possible to obtain a photographing path on each of a plurality of floors without inputting a photographing start spot on each of the floors.

### BRIEF DESCRIPTION OF THE DRAWINGS

FIG. 1 is a diagram showing a general configuration of an information processing system according to Embodiment 1.

FIG. 2 is a flowchart showing a process of the information processing system according to Embodiment 1.

FIG. 3 shows exemplary design drawings.

FIG. 4 is a flowchart showing a process of an information processing system according to Embodiment 2.

FIG. 5 is a flowchart following that of FIG. 4.

FIG. 6 is a flowchart showing a process according to Embodiment 3.

### DETAILED DESCRIPTION

### Knowledge Underlying the Present Disclosure

There is ongoing progress in developing a user interface configured to display, on a two-dimensional design drawing reflecting a work site and the like, a plurality of photographing spot icons each indicating a photographing spot at which an image of the work site is actually captured, and to display, when one photographing spot icon is selected, an image captured at the photographing spot indicated by the one photographing spot icon. This enables a manager for the work site to grasp a situation in the work site without visiting the work site.

In the user interface described above, a photographing spot is registered in a manner described below. First, the photographing person inputs a photographing start spot on a design drawing, and captures an image of a work site by a camera while moving in the work site. When the photographing is completed, the photographing person inputs a photographing end spot on the design drawing, and uploads the captured image to a server. The server calculates a photographing spot of each image by executing self-localization using the uploaded images, the photographing start spot, and the photographing end spot, and plots the calculated photographing spots on the design drawing. Accordingly, a photographing path connecting a plurality of photographing spots can be obtained.

Coordinate values of a photographing spot calculated by the self-localization technique are two-dimensional and do not contain elevation information. This is why the photographing person is required to input a photographing start spot on each of a plurality of floors to generate the photographing path on each of the floors. This puts a burden on the photographing person.

The present inventors have obtained the knowledge that, if elevation information indicative of an elevation of each photographing spot is acquired during the photographing, it would be possible to recognize on which floor each image was captured, consequently enabling the generation of a photographing path on each of the floors without requiring inputting of a photographing start spot on each of the floors. This finding consequently led the present inventors to work out the present disclosure.
(1) An information processing method according to an aspect of the present disclosure is an information processing method by a computer, and includes generating a photographing path from a photographing start spot to a photographing end spot having a plurality of floors, from a plurality of bird's-eye views covering the floors and a plurality of images captured at a plurality of photographing spots including the photographing start spot and the photographing end spot; and linking, on the basis of elevation information indicative of an elevation of each of the photographing spots, a photographing spot being in a first photographing section having a constant elevation to a first bird's-eye view among the bird's-eye views, and a photographing spot being in a second photographing section having a constant elevation after an elevation change to a second bird's-eye view among the bird's-eye views and different from the first bird's-eye view.

In this configuration, a photographing spot in the first photographing section having a constant elevation is linked to the first bird's-eye view among the bird's-eye views, and a photographing spot in the second photographing section having a constant elevation after an elevation change indicated by the elevation information is linked to the second bird's-eye view among the bird's-eye views and different from the first bird's-eye view. This makes it possible to obtain a photographing path on each of the floors without inputting a photographing start spot on each of the floors. In the present disclosure, the constant elevation includes an elevation that is indicated to be within a certain range assuring a constant elevation judgement by the elevation information.
(2) In the information processing method recited in the above (1), the elevation information may be obtained by a barometric pressure sensor or a pressure change sensor.

In this case, accurate elevation information can be obtained by the barometric pressure sensor or the pressure change sensor.
(3) In the information processing method recited in the above (1) or (2), it may be appreciated that the photographing path is generated after acquisition of all the images, and the linking is executed after the complete generation of the photographing path for all the images.

In this case, after the completion of the photographing action, respective photographing paths on the floors can be obtained in bulk.
(4) In the information processing method recited in the above (1) or (2), it may be appreciated that a photographing path is generated each time one of the images is acquired, and the linking is executed after each generation of the photographing path.

In this case, a photographing path can be obtained in real time during the photographing action.
(5) In the information processing method recited in any one of the above (1) to (4), it may be appreciated that the generation includes calculating the photographing spots by executing self-localization using the photographing start spot and the images, and generating the photographing path from the calculated photographing spots.

In this case, the plurality of photographing spots is calculated by self-localization. Therefore, the photographing path can be calculated at a high accuracy.
(6) The information processing method recited in the above (4) may further include acquiring a coordinate value of a marking spot that is a photographing spot specified by a photographing person during photographing, and it may be appreciated that a photographing path after the marking spot is acquired is generated by executing self-localization using the marking spot each time one image is acquired.

In this case, the marking spot is inputted during the photographing. Therefore, the photographing path thereafter can be generated at a high accuracy.
(7) An information processing apparatus according to another aspect of the present disclosure includes a processor that executes: generation of a photographing path from a photographing start spot to a photographing end spot having a plurality of floors, from a plurality of bird's-eye views covering the floors and a plurality of images captured at a plurality of photographing spots including the photographing start spot and the photographing end spot; and linking of, on the basis of elevation information indicative of an elevation of each of the photographing spots, a photographing spot being in a first photographing section having a constant elevation to a first bird's-eye view among the bird's-eye views, and a photographing spot being in a second photographing section having a constant elevation after an elevation change to a second bird's-eye view among the bird's-eye views and different from the first bird's-eye view.

In this case, the information processing apparatus that enables generation of a photographing path on each of the floors without requiring inputting of a photographing start spot on each of the floors is provided.
(8) An information processing program according to still another aspect of the present disclosure causes a computer to execute: generation of a photographing path from a photographing start spot to a photographing end spot having a plurality of floors, from a plurality of bird's-eye views covering the floors and a plurality of images captured at a plurality of photographing spots including the photographing start spot and the photographing end spot; and linking of, on the basis of elevation information indicative of an elevation of each of the photographing spots, a photographing spot being in a first photographing section having a constant elevation to a first bird's-eye view among the bird's-eye views, and a photographing spot being in a second photographing section having a constant elevation after an elevation change to a second bird's-eye view among the bird's-eye views and different from the first bird's-eye view.

In this case, the information processing program that enables generation of a photographing path on each of the floors without requiring inputting of a photographing start spot on each of the floors is provided.

The present disclosure may be implemented as an information processing system which operates in accordance with the information processing program. It is needless to say that the computer program may be distributed via a computer-readable non-transitory recording medium such as a CD-ROM or a communication network such as Internet.

Each of embodiments described below shows a specific example of the present disclosure. Numerical values, shapes, elements, steps, order of steps, and the like that are indicated in the following embodiments are merely examples, and are not intended to delimit the present disclosure. Among the elements in the following embodiments, elements not recited in the independent claims representing the broadest concepts are described as optional elements. In all the embodiments, the respective contents may also be combined.

### Embodiment 1

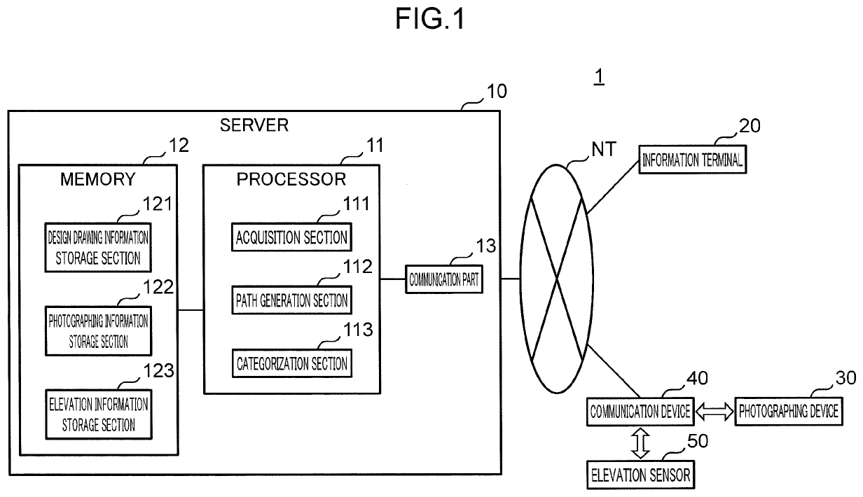

FIG. 1 is a diagram showing a general configuration of an information processing system 1 according to Embodiment 1. The information processing system 1 obtains a photographing path of a moving photographing person from a plurality of images of a certain space captured by the photographing person while moving across a plurality of floors. The information processing system 1 includes a server 10, an information terminal 20, a photographing device 30, a communication device 40, and an elevation sensor 50. The server (an example of an information processing apparatus and a computer) 10, the information terminal 20, and the communication device 40 are mutually communicably connected via a network NT. An example of the network is the Internet. For example, the server 10 is a cloud server having one or a plurality of computers. However, this is merely an example. The server 10 may be an edge server or may be implemented in the information terminal 20. In a configuration where a server 10 is provided in an information terminal 20, the information terminal 20 may be configured in an information processing apparatus.

The information terminal 20 is carried by a user. For example, the user is a manager for a certain space to be photographed by the photographing device 30. For example, the certain space is a construction site. However, this is merely an example. The certain space may be a work site, a factory, a store, or an office. For example, the information terminal 20 may be configured by a portable computer such as a smartphone and a tablet computer, or a stationary computer. The information terminal 20 is adapted to display an image on a display under a control of the server 10. FIG. 1 shows only one information terminal 20 as an example. However, a plurality of information terminals may be connected to the server 10 via a network.

For example, the communication device 40 is configured by a portable information terminal such as a smartphone and a tablet computer, and connects the photographing device 30 and the elevation sensor 50 to the network NT. The communication device 40 and the photographing device 30 are connected via a short-range wireless communication path such as Bluetooth (registered trademark). The communication device 40 and the elevation sensor 50 are connected via a short-range wireless communication path such as Bluetooth (registered trademark). The communication device 40 is carried by a photographing person.

The elevation sensor 50 is a sensor for obtaining elevation information of a photographing spot, and is carried by a photographing person. The elevation sensor 50 includes, for example, a barometric pressure sensor or a pressure change sensor. The elevation sensor 50 regularly obtains elevation information indicative of an elevation of a photographing spot in a photographing period. The photographing period indicates a period from a start to an end of a photographing by the photographing person.

Specifically, the elevation sensor 50 includes a sensor part, a processor, and a communication part. The sensor part includes a barometric pressure detection section or a pressure change detection section. The processor converts a barometric pressure value or a pressure change value that is detected by the sensor part into an elevation with respect to the ground to thereby generate elevation information. The communication part sends the elevation information generated by the processor to the server 10 via the communication device 40.

In the example of FIG. 1, the elevation sensor 50 is connected to the network NT via the communication device 40. However, this is merely an example. For example, the elevation sensor 50 may be provided in the communication device 40.

For example, the photographing device 30 includes an omnidirectional camera, and captures an image at a predetermined frame rate. The omnidirectional camera, which is called as a 360-degree camera, is a camera capable of capturing an omnidirectional image covering 360 degrees. For example, the photographing device 30 is a portable photographing device carried by the photographing person. For example, the photographing person is an operator or a site foreman in a construction site. The photographing device 30 may be an ordinary camera.

The photographing person moves in the certain space while photographing the construction site by the photographing device 30. When the photographing is completed, the photographing device 30 is allowed to send photographing information including a series of captured images to the server 10 via the communication device 40. When the photographing is completed, the elevation sensor 50 sends elevation information obtained in the photographing period to the server 10 via the communication device 40.

The photographing information includes captured images, a photographing start spot, a photographing end spot, and a design drawing ID corresponding to the certain space. The design drawing ID is an identifier of identifying a design drawing of the certain space.

At the photographing start position, the photographing person sets a photographing direction of the photographing device 30 to north and presses a photograph start button on the photographing device 30 to thereby start photographing. When arriving at the photographing end spot, the photographing person presses the photograph button again to thereby end the photographing. In particular, in this embodiment, the photographing person performs the photographing action through a plurality of floors.

The photographing start spot and the photographing end spot are determined by the photographing person inputting an instruction of specifying their respective positions in a design drawing showing the certain space on the display of the communication device 40. Two-dimensional coordinate axes are defined over the design drawing. Therefore, the photographing start spot and the photographing end spot are defined by two-dimensional coordinate values. The photographing start spot and the photographing end spot are used in order that the server 10 determines a position of each photographing spot and a photographing direction of each image.

The server 10 includes a processor 11, a memory 12, and a communication part 13. For example, the processor 11 includes a central processing unit (CPU). The processor 11 includes an acquisition section 111, a path generation section 112, and a categorization section 113. The acquisition section 111 to the categorization section 113 may be accomplished by an information processing program executed by the processor 11, or may be accomplished by a dedicated hardware circuit such as ASIC.

The acquisition section 111 acquires via the communication part 13 photographing information sent from the photographing device 30 via the communication device 40 and elevation information sent from the elevation sensor 50 via the communication device 40. The acquired photographing information is stored in a photographing information storage section 122. The acquired elevation information is stored in an elevation information storage section 123.

The acquisition section 111 acquires design drawing information corresponding to the photographing information from a design drawing information storage section 121. The acquisition section 111 may acquire the design drawing information corresponding to the photographing information by a photographing ID included in the photographing information as a key. The design drawing information of the certain space photographed by the photographing person is thus obtained.

The path generation section 112 generates a photographing path from a photographing start spot to a photographing end spot having a plurality of floors, from a plurality of design drawings (an example of a bird's-eye view) covering the floors and a plurality of images captured at a plurality of photographing spots including the photographing start spot and the photographing end spot.

The path generation section 112 calculates each of the photographing spots by executing self-localization using the photographing start spot, the photographing end spot, and the images that are included in the photographing information. As the self-localization, VSLAM (Visual simultaneous localization and mapping) may be adopted.

The photographing path connects a plurality of photographing spots. The photographing path represents a moving route of the photographing person. The position of each photographing spot is represented by two-dimensional coordinate values on a design drawing. The photographing direction of each image is determined by the self-localization. The photographing direction of each image may be expressed by vectors in three-dimensional polar coordinates, for example. Alternatively, the photographing direction of each image may be expressed by vectors in two-dimensional polar coordinates on a two-dimensional polar coordinate space parallel to a horizontal direction.

The path generation section 112 generates a photographing path after acquisition of all the images captured in the photographing period.

The path generation section 112 detects, by way of image processing, feature points of each of a plurality of images included in the photographing information. The feature point is a characteristic point of an object included in the image, such as a contour or the like. The path generation section 112 executes self-localization using at least two images among the images having the feature point to each of images to thereby calculate relative coordinate values of a photographing spot, i.e., self-position, of each image. The path generation section 112 adjusts orientations at the respective photographing spots of the images to agree with one another on the basis that the photographing device 30 is set to north at the start of a photographing action. The path generation section 112 calculates absolute coordinate values of the respective photographing spots of the images from the relative coordinate values of the respective photographing spots of the images with reference to coordinate values of the photographing start spot and the photographing end spot which are included in the photographing information. The path generation section 112 generates a path connecting the series of photographing spots as a photographing path.

The categorization section 113 links, on the basis of elevation information indicative of an elevation of each of the photographing spots, a photographing spot being in a first photographing section having a constant elevation to a first bird's-eye view among the bird's-eye views. Further, the categorization section 113 links a photographing spot being in a second photographing section having a constant elevation after an elevation change indicated by the elevation information to a second bird's-eye view among the bird's-eye views and different from the first bird's-eye view.

The first photographing section is a section photographed by the photographing person on the first floor. The second photographing section is a section photographed by the photographing person on the second floor. The first bird's eye view is a design drawing of the first floor, whereas the second bird's eye view is a design drawing of the second floor. The bird's-eye view may be an overlooking view, other than a design drawing, of a certain space. Alternatively, the bird's-eye view may be an overlooking representation of the certain space by computer graphics. The first floor and the second floor are not meant to restrict the certain space to two floors but are meant to indicate that the certain space includes a plurality of floors. In other words, the present disclosure may be applied to a certain space including three or more floors. The first floor may be either below the second floor or above the second floor. Accordingly, the photographing path is linked to the floors. The design drawing is a drawing showing a design of a construction site, and may be a plan view, a blueprint, a map, or a perspective view of the construction site. The bird's-eye view is also called as an overlooking view, and may be either an overlooking view or a view from a high place.

The categorization section 113 executes processing of categorizing the photographing spots into each of the floors after the complete generation of the photographing path for all the images.

The memory 12 is a non-volatile rewritable storage device such as a hard disk drive and a solid-state drive. The memory 12 includes the design drawing information storage section 121, the photographing information storage section 122, and the elevation information storage section 123. The design drawing information storage section 121 stores design drawing information. The design drawing information is image information showing a design drawing of the certain space. The design drawing information is linked with a design drawing ID of identifying the design drawing.

The photographing information storage section 122 stores photographing information sent from the photographing device 30. The photographing information includes a plurality of images, a photographing start spot, a photographing end spot, and a design drawing ID that are included in the photographing information sent from the photographing device 30, and in addition, meta-information of each of the images. The photographing information is generated each time the photographing information is sent. The meta-information includes a photographing ID, a photographing period ID, a photographing date and time, a photographing direction, and a photographing spot.

The photographing ID is an identifier of a photographing spot. The photographing period ID is an identifier of a photographing period. The photographing date and time indicates a date and time at which an image is captured. The photographing direction is a direction in which each image is captured by the photographing device 30. The photographing spot is a position (two-dimensional coordinate values) indicating a spot at which an image is captured.

The elevation information storage section 123 stores elevation information sent from the elevation sensor 50 via the communication device 40. The elevation information is linked with a design drawing ID and a detection date and time. Therefore, the path generation section 112 can determine elevation information of a photographing spot by comparing the design drawing ID and the detection date and time that are linked to the elevation information with a design drawing ID and a photographing date and time that are linked to the image.

The communication part 13 is a communication interface for connecting the server 10 to the network.

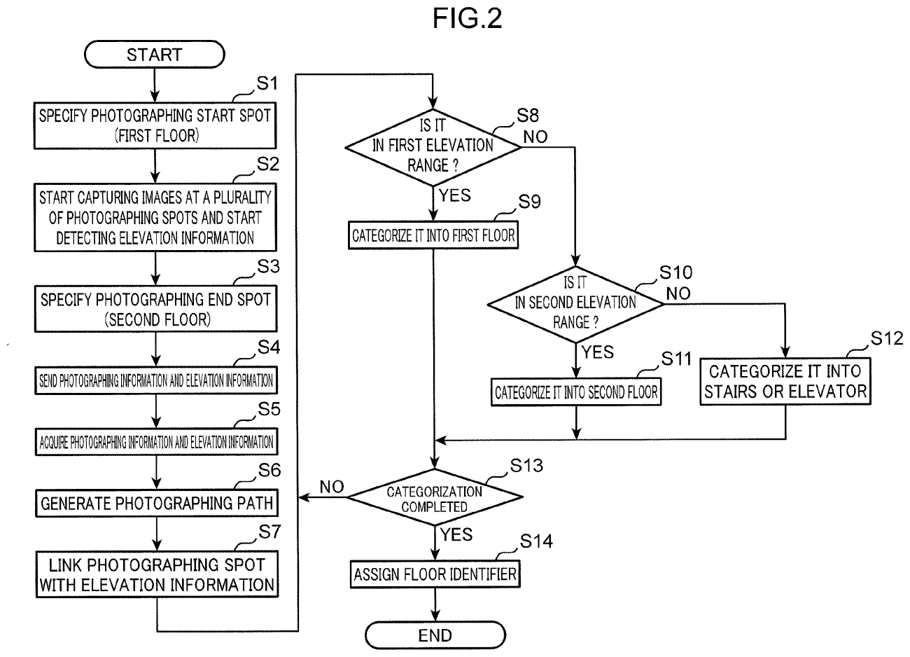

FIG. 2 is a flowchart showing a process of the information processing system 1 according to Embodiment 1. In this flowchart, the certain space includes the first floor and the second floor. Accordingly, the design drawing of the certain space includes the design drawing of the first floor and the design drawing of the second floor.

In Step S1, an operation part of the communication device 40 receives an operation of inputting a photographing start spot. For example, the photographing person inputs an operation of specifying the photographing start spot to the design drawing displayed on the display of the communication device 40. The photographing person may specify the photographing start spot by tapping on the design drawing or specify coordinate values of the photographing start spot.

Next, in Step S2, the photographing device 30 starts capturing a plurality of images at a plurality of photographing spots, and the elevation sensor 50 starts processing of regularly detecting elevation information. On the first floor, the photographing person sets a photographing direction of the photographing device 30 to north and inputs a photographing start instruction to the photographing device 30 to thereby cause a start of a photographing action in the certain space.

The photographing person first photographs the first floor. When the photographing on the first floor ends, the photographing person moves to the second floor by using ascending and descending means such as stairs and elevator without ending the photographing, and arrives at a photographing end spot. At this moment, the photographing person inputs a photographing end instruction to the photographing device 30 to thereby end the photographing action.

Next, in Step S3, the operation part of the communication device 40 receives an operation of inputting the photographing end spot. For example, the photographing person inputs an operation of specifying the photographing end spot to the design drawing displayed on the display of the communication device 40. The photographing person may either specify the photographing end spot by tapping on the design drawing or specify the photographing end spot by inputting coordinate values of the photographing end spot.

Next, in Step S4, the communication device 40 acquires from the photographing device 30 photographing information including the images captured by the photographing device 30 in the photographing period, and acquires from the elevation sensor 50 the elevation information regularly detected by the elevation sensor 50 in the photographing period, and sends the acquired photographing information and the acquired elevation information to the server 10.

Next, in Step S5, the acquisition section 111 acquires the photographing information and the elevation information that are sent from the communication device 40 via the communication part 13. The acquired photographing information is added with meta-information and then stored in the photographing information storage section 122. The acquired elevation information is stored in the elevation information storage section 123.

Next, in Step S6, the path generation section 112 calculates, using self-localization, a photographing spot of each of the images included in the photographing information acquired in Step S5, and generates a photographing path from the calculated photographing spots.

Next, in Step S7, the path generation section 112 links the photographing spots generated in Step S6 with elevation information corresponding to each of the photographing spots.

Next, in Step S8, the categorization section 113 retrieves photographing spots (attentional photographing spots) one by one in order of photographing date and time among the photographing spots generated in Step S6 and determines whether an elevation indicated by elevation information linked to the attentional photographing spot is within a first elevation range H1. The first elevation range H1 encompasses a lower limit value of H11 or more and an upper limit value of H12 or less. The lower limit value H11 is set at an elevation of a floor surface of the first floor from the ground. The upper limit value H12 is set at an elevation from the ground that is obtained by adding a certain margin to an elevation of the elevation sensor 50 carried by the photographing person standing on the first floor. The lower limit value H11 and the upper limit value H12 may be set at predetermined values.

The categorization section 113 may determine that the attentional photographing spot is on the first floor when a difference in elevation between the current attentional photographing spot and a photographing spot having been the attentional photographing spot immediately before is smaller than a certain value, and determine that the attentional photographing spot is not on the first floor when the difference is equal to or greater than the certain value.

When the elevation of the attentional photographing spot is within the first elevation range H1 (YES in Step S8), the flow proceeds to Step S9. When the elevation of the attentional photographing spot is not within the first elevation range H1 (NO in Step S8), the flow proceeds to Step S10.

Next, in Step S9, the categorization section 113 categorizes the attentional photographing spot into the first floor.

Next, in Step S10, the categorization section 113 determines whether the elevation of the attentional photographing spot is within a second elevation range H2 or not. The second elevation range H2 encompasses a lower limit value of H21 or more and an upper limit value of H22 or less. The lower limit value H21 is set at an elevation of a floor surface of the second floor from the ground. The upper limit value H22 is set at an elevation from the ground that is obtained by adding a certain margin to an elevation of the elevation sensor 50 carried by the photographing person standing on the second floor. The lower limit value H21 and the upper limit value H22 may be set at predetermined values.

When the elevation of the attentional photographing spot is within the second elevation range H2 (YES in Step S10), the flow proceeds to Step S11. When the elevation of the attentional photographing spot is not within the second elevation range H2 (NO in Step S10), the flow proceeds to Step S12.

Next, in Step S11, the categorization section 113 categorizes the attentional photographing spot into the second floor.

Next, in Step S12, the categorization section 113 categorizes an attentional photographing spot that is in neither the first floor nor the second floor into stairs or elevator. The categorization section 113 may categorize an image captured on stairs or elevator as an image of a transfer section. Further, the categorization section 113 may categorize an image captured on stairs or elevator as an image of a construction step of stairs or elevator.

Next, in Step S13, the categorization section 113 determines whether the categorization is completed. For example, the categorization section 113 determines to be YES in Step S13 when the categorization processing of the photographing end spot as the attentional photographing spot is completed, and the process ends. On the other hand, the categorization section 113 determines to be NO in Step S13 when the categorization processing of the end spot as the attentional photographing spot is not completed, and the flow returns to Step S8.

Next, in Step S14, the categorization section 113 assigns a floor identifier indicative of the first floor to the photographing spot categorized into the first floor and stores it in the photographing information storage section 122, and assigns a floor identifier indicative of the second floor to the photographing spot categorized into the second floor and stores it in the photographing information storage section 122. The categorization section 113 may assign an identifier indicative of stairs or elevator to the photographing spot categorized into stairs or elevator and store it in the photographing information storage section 122.

In the flowchart in FIG. 2, the certain space includes two floors. However, the certain space may include three or more floors. In this case, the flowchart may include n determination processings for determining whether the attentional photographing spot is in an n-th (n is an integer of one or more) elevation range.

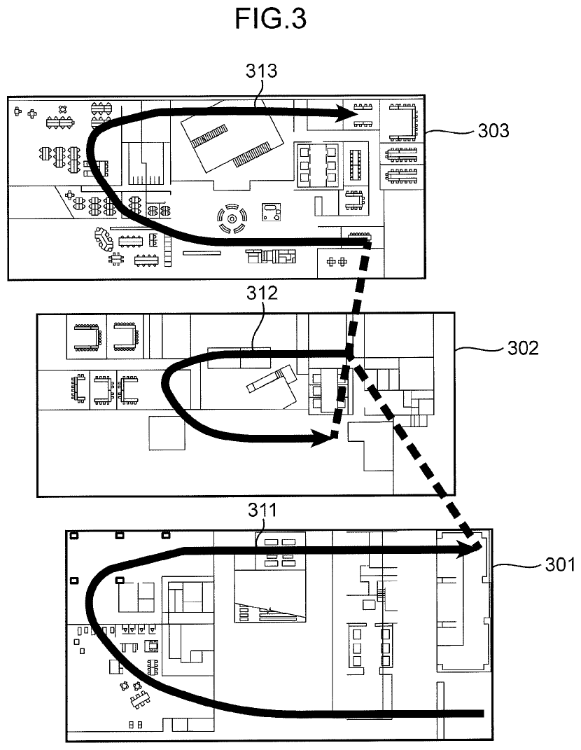

FIG. 3 shows exemplary design drawings. In this example, design drawings 301, 302, and 303 of a first floor, a second floor, and a third floor are shown.

The design drawing 301 includes a photographing path 311. The photographing path 311 includes a line connecting photographing spots categorized into the first floor. The design drawing 302 includes a photographing path 312. The photographing path 312 includes a line connecting photographing spots categorized into the second floor. The design drawing 303 includes a photographing path 313. The photographing path 313 includes a line connecting photographing spots categorized into the third floor. The photographing path 311 may include a photographing spot icon indicative of a photographing spot.

When a display instruction of a design drawing is inputted by a user at an information terminal 20 via an operation part of the information terminal 20, the processor 11 displays the design drawings 301 to 303 on the display of the information terminal 20. Accordingly, the design drawings 301 to 303 shown in FIG. 3 are displayed on the display of the information terminal 20. Alternatively, when a designation instruction of a floor is inputted by the user together with the display instruction of the design drawing via the operation part of the information terminal 20, the processor 11 may display the design drawing of the designated floor on the display of the information terminal 20. Accordingly, the design drawing of the designated floor is displayed on the display of the information terminal 20.

When a selection instruction of a photographing spot icon is inputted by the user via the operation part of the information terminal 20, the processor 11 displays an image corresponding to the photographing spot icon on the display of the information terminal 20. This allows the user to see a situation around the selected photographing spot.

In this manner, according to this embodiment, a photographing spot in the first photographing section having a constant elevation is linked to a design drawing of the first floor among the design drawings, and a photographing spot in the second photographing section having a constant elevation after an elevation change indicated by the elevation information is linked to a design drawing of the second floor. Accordingly, a photographing path on each of a plurality of floors can be obtained without inputting a photographing start spot on each of the floors.

### Embodiment 2

In Embodiment 2, a photographing spot is categorized into a floor in real time. In this embodiment, the same elements as those of Embodiment 1 are allotted with the same reference numerals. The description of the same elements is omitted. The block diagram in FIG. 1 is used for this embodiment, too.

FIG. 1 is referred to. Each time a photographing device 30 captures an image, the photographing device 30 sends photographing information including the image to a server 10 via a communication device 40.

A path generation section 112 generates a photographing path each time one image is acquired among a plurality of images by an acquisition section 111.

The path generation section 112 detects a feature point of an image in the same manner as in Embodiment 1. The path generation section 112 executes self-localization to calculate relative coordinate values of a photographing spot of each image using at least two images, that is, an image currently acquired and one, or a plurality of already acquired images, each time a plurality of images is acquired. The path generation section 112 adjusts an orientation of a photographing spot on the basis that the photographing device 30 is set to north at a start of photographing. The path generation section 112 calculates absolute coordinate values of a self-position for each image by using a plurality of marking spots corresponding to a plurality of photographing spots specified by the photographing person on a design drawing at the start of the photographing, and designates the calculated absolute coordinate values as coordinate values of the photographing spot of the image. Each time a photographing spot is calculated for an image, the path generation section 112 displays a photographing spot icon indicating the photographing spot and a photographing path, i.e., a line connecting photographing spot icons calculated thus far, on a design drawing displayed on a display of an information terminal 20.

After the processing of generating the photographing path is executed by the path generation section 112, a categorization section 113 executes a processing of categorizing photographing spots into respective floors. The photographing path is thus linked to floors.

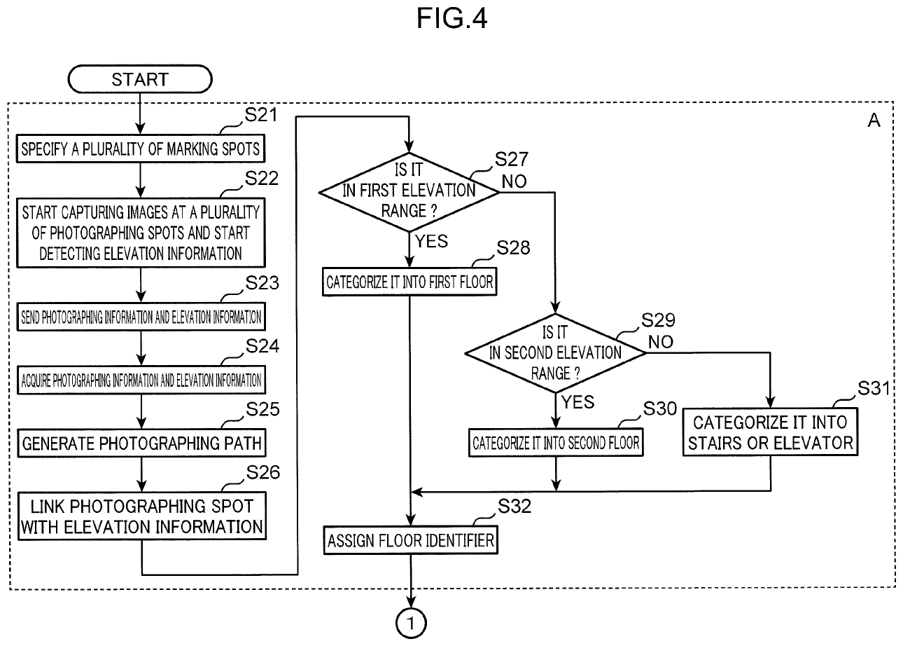

FIG. 4 is a flowchart showing a process of the information processing system 1 according to Embodiment 2. In Step S21, an operation part of the communication device 40 receives an operation to input marking spots corresponding to a plurality of photographing spots. For example, the photographing person specifies photographing spots over a design drawing displayed on a display of the communication device 40. The photographing person may specify photographing spots by tapping on the design drawing or specify coordinate values of photographing spots. The marking spots may include a photographing start spot.

The processing in Step 22 is identical to that in Step S2.

Next, in Step S23, the communication device 40 acquires, from the photographing device 30, photographing information including a plurality of images captured by the photographing device 30 while the marking spots are specified, and acquires, from the elevation sensor 50, elevation information that has not been sent in a period from the start of the photographing to the present, and sends the acquired photographing information and the elevation information to the server 10. The photographing information includes coordinate values of each of the marking spots, a photographing date and time and a design drawing ID of each of the images.

The processing in Step 24 is identical to that in Step S5.

Next, in Step S25, the path generation section 112 calculates, using self-localization, a photographing spot of each of the images included in the photographing information acquired in Step S24 to thereby generate a photographing path from the start of the photographing to the photographing spot of the most recent image.

Specifically, the path generation section 112 obtains relative coordinate values of a photographing spot from the images acquired in Step S24. The path generation section 112 adjusts an orientation of the photographing spot of each image on the basis that the photographing device is set to north at the photographing start spot. The path generation section 112 calculates absolute coordinate values of the photographing spot of each image from the relative coordinate values of the photographing spot of each image by using coordinate values of the marking spot. The path generation section 112 generates a photographing path that is a line connecting the calculated photographing spots.

The processings in Steps S26, S27, S28, S29, S30, and S31 are identical to those in Steps S7, S8, S9, S10, S11, and S12.

The processing in Step S32 is identical to that in Step S14 except that the processing is executed for photographing spots including the marking spots generated in Step S25 instead of all the photographing spots in the photographing period.

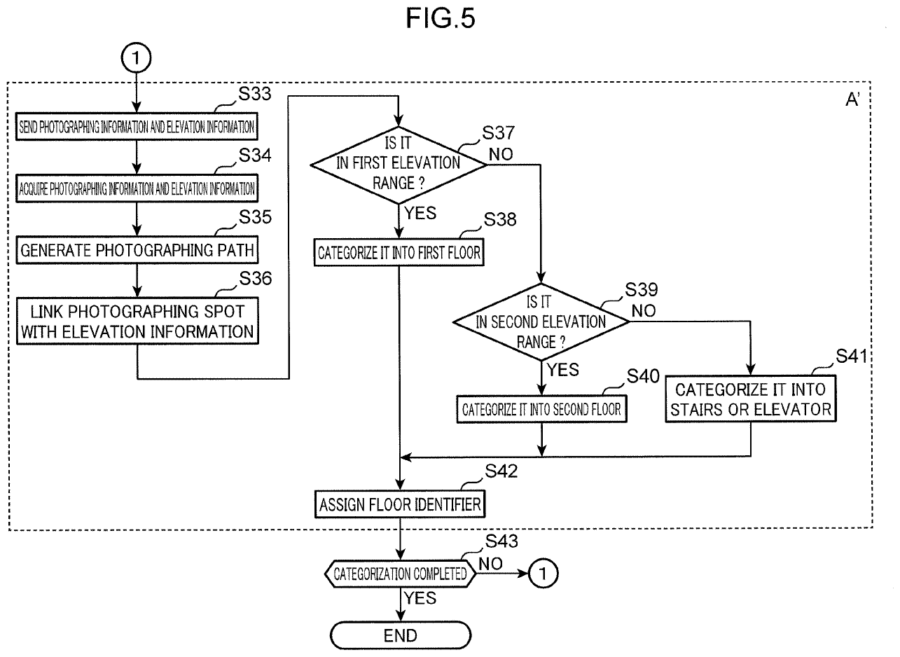

FIG. 5 is a flowchart following that of FIG. 4. Next, in Step S33, the communication device 40 acquires, from the photographing device 30, photographing information including the most recent one image captured by the photographing device 30, and acquires, from the elevation sensor 50, the elevation information detected by the elevation sensor 50 in a frame cycle corresponding to the one image, and sends the acquired photographing information and the elevation information to the server 10. The photographing information includes a photographing date and time, a design drawing ID of the most recent one image.

The processing in Step 34 is identical to that in Step S24.

The processing in Step S35 is identical to that in Step S25 except that the processing is executed on the most recent one image.

The processings in Steps S36, S37, S38, S39, S40, and S41 are identical to those in Steps S26, S27, S28, S29, S30, and S31. In other words, processing of categorizing the most recent photographing spot into a floor is executed.

The processing in Step S42 is identical to that in Step S14 except that the processing is executed for the most recent photographing spot generated in Step S35 instead of all the photographing spots in the photographing period.

In Step S43, the categorization section 113 determines whether the categorization is completed. For example, the categorization section 113 determines to be YES in Step S43 when the categorization processing of the photographing end spot as the attentional photographing spot is completed, and the process ends. On the other hand, the categorization section 113 determines to be NO in Step S43 when the categorization processing of the photographing end spot as the attentional photographing spot is not completed, and the flow returns to Step S33.

Accordingly, in this embodiment, a photographing path can be obtained in real time during a photographing action.

### Embodiment 3

In Embodiment 3, a photographing path in Embodiment 2 is generated using a marking spot acquired during the photographing. In Embodiment 3, the same elements as those of Embodiments 1 and 2 are allotted with the same reference numerals. The description of the same elements is omitted. The block diagram in FIG. 1 is used for this embodiment, too.

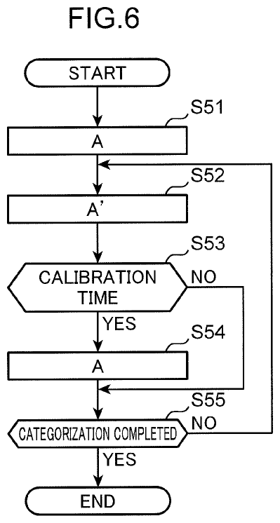

FIG. 6 is a flowchart showing a process according to Embodiment 3. First, in Step S51, an information processing system 1 executes Process A. Process A includes processings of Steps S21 to S32 shown in FIG. 4.

Next, in Step S52, the information processing system 1 executes Process A′. Process A′ includes processings of Steps S33 to S42 shown in FIG. 5.

Next, in Step S53, the path generation section 112 determines whether a calibration time has reached or not. For example, the calibration time may be at fixed intervals, may be a time at which calculated photographing spots reaches a predetermined number, or may be a time at which a deviation of a photographing path (coordinates) exceeds a certain value. When the calibration time has reached (YES in Step S53), the flow proceeds to Step S54. When the calibration time has not reached yet (NO in Step 53), the flow proceeds to Step S55.

Next, in Step S54, the information processing system 1 executes Process A. In this case, in the processing of Step S21, one or more photographing spots at which a photographing person executes photographing in a certain space during a photographing period are specified as a marking spot instead of a plurality of photographing spots including the photographing start spot. Further, in Step S25, absolute coordinate values of a photographing spot are generated from relative coordinate values of the photographing spot using the one or more marking spots specified in Step S21. The path generation section 112 calculates a photographing spot by executing self-localization using the marking spot each time one image is captured after the acquisition of the acquired marking spot. Further, when a subsequent marking spot is acquired, the path generation section 112 calculates a photographing spot by executing self-localization using the subsequent marking spot each time one image is acquired.

Accordingly, in this embodiment, a marking spot of a photographing spot is acquired during the photographing period. Therefore, in calculation of a photographing spot in real time, the calculation accuracy of the photographing spot will further increase.

The present disclosure is useful in the technical field of managing a progress state of a site from a remote place.

1. An information processing method, by a computer, comprising:
generating a photographing path from a photographing start spot to a photographing end spot in a space having a plurality of floors, from a plurality of bird's-eye views corresponding respectively to the plurality of floors and a plurality of images captured at a plurality of photographing spots including the photographing start spot and the photographing end spot; and
linking, based on elevation information indicative of an elevation of each of the plurality of photographing spots,
each photographing spot having an elevation within a first predetermined elevation range to a fist bird's-eye view corresponding to a first floor among the plurality of bird's-eye views, and
each photographing spot having an elevation within a second predetermined elevation range after a change from the first predetermined elevation range to the second predetermined elevation range to a second bird's-eye view corresponding to a second floor among the plurality of bird's-eye views, the second bird's-eye view being different from the first bird's-eye view.

2. The information processing method according to claim 1,
wherein the elevation information is obtained by a barometric pressure sensor or a pressure change sensor.

3. The information processing method according to claim 1,
wherein the photographing path is generated after acquisition of all the images, and
the linking is executed after the complete generation of the photographing path for all the images.

4. The information processing method according to claim 1,
wherein a photographing path is generated each time one of the images is acquired, and
the linking is executed after each generation of the photographing path.

5. The information processing method according to claim 1,
wherein the generation includes calculating the photographing spots by executing self-localization using the photographing start spot and the images, and generating the photographing path from the calculated photographing spots.

6. The information processing method according to claim 4, further comprising acquiring a coordinate value of a marking spot that is a photographing spot specified by a photographing person during photographing,
wherein a photographing path after the marking spot is acquired is generated by executing self-localization using the marking spot each time one image is acquired.

7. An information processing apparatus comprising a processor that executes:
generation of a photographing path from a photographing start spot to a photographing end spot in a space having a plurality of floors, from a plurality of bird's-eye views corresponding respectively to the plurality of floors and a plurality of images captured at a plurality of photographing spots including the photographing start spot and the photographing end spot; and
linking of, based on elevation information indicative of an elevation of each of the plurality of photographing spots,
each photographing spot having an elevation within a first predetermined elevation range to a fist bird's-eye view corresponding to a first floor among the bird's-eye views, and
each photographing spot having an elevation within a second predetermined elevation range after a change from the first predetermined elevation range to the second predetermined elevation range to a second bird's-eye view corresponding to a second floor among the bird's-eye views, the second bird's-eye view different from the first bird's-eye view.

8. A non-transitory computer readable recording medium storing an information processing program causing a computer to execute:
generation of a photographing path from a photographing start spot to a photographing end spot in a space having a plurality of floors, from a plurality of bird's-eye views corresponding respectively to floors and a plurality of images captured at a plurality of photographing spots including the photographing start spot and the photographing end spot; and
linking of, based on elevation information indicative of an elevation of each of plurality of photographing spots,
each photographing spot having an elevation within a first predetermined elevation range to a fist bird's-eye view corresponding to a first floor among the bird's-eye views, and
each photographing spot having an elevation within a second predetermined elevation range after a change from the first predetermined elevation range to the second predetermined elevation range to a second bird's-eye view corresponding to a second floor among the plurality of bird's-eye views, the second bird's-eye view being different from the first bird's-eye view.
